(19) United States
(12) Patent Application Publication
(10) Pub. No.: US 2012/0258203 A1
(43) Pub. Date: Oct. 11, 2012

(54) Nutritional Supplement Without Vitamin A

(76) Inventors: Aprille Ciavarella, Henderson, NV (US); Katie Louise Oliver, Peterborough (CA); Victoria Lorraine Pianarosa, Bedford (CA)

(21) Appl. No.: 12/566,148

(22) Filed: Sep. 24, 2009

(51) Int. Cl. A23L 1/30; A23L 1/304; A23L 1/305; A23L 1/303

(52) U.S. Cl. 426/73

(57) ABSTRACT

This invention relates to a dietary supplement that is specifically designed for use in three categories of patient type; patients undergoing treatment with oral or topical forms of retinoids such as Isotretinoin, Tretinoin and Retinoic Acid; patients with medical conditions/treatments that are aggravated by the consumption of Vitamin A; individuals in the prenatal period wishing to avoid the consumption of Vitamin A in supplements.

The dietary supplement is not limited by the inclusion of specific vitamins, minerals or other nutrients, but rather the exclusion specifically of Vitamin A and/or its precursors for the purpose outlined above.

### TECHNICAL FIELD

This invention relates to dietary supplement compositions specifically without Vitamin A or its precursors, and more particularly, optimized for administration to patients taking topical or oral forms of retinoids such as Isotretinoin, Tretinoin and Retinoic Acid. The invention further relates to nutritional supplements optimized for individuals with medical conditions that are aggravated by the consumption of Vitamin A, or individuals in the prenatal period wishing to avoid the consumption of Vitamin A.

### BACKGROUND OF THE INVENTION

This invention relates to a dietary supplement that is specifically designed for use in three categories of patient type; patients undergoing treatment with oral or topical forms of retinoids such as Isotretinoin, Tretinoin and Retinoic Acid; patients with medical conditions/treatments that are aggravated by the consumption of Vitamin A; individuals in the prenatal period wishing to avoid the consumption of Vitamin A in supplements.

Hypervitaminosis A, or Vitamin A toxicity refers to high levels of vitamin A in the body that can lead to toxic symptoms. There are four major adverse effects toxicity: birth defects, liver abnormalities, reduced bone mineral density that may result in osteoporosis and central nervous system disorders

Isotretinoin, Tretinoin and Retinoic Acid (Brand Names: Accutane, Amnesteem, Claravis, Claws, Decutan, Isotane, Izotek, Isotrex, Isotrexin, Oratane, Roaccutane, Sotret, RoC, Retin-A and Retinal) are retinoids which are chemically related to Vitamin A. They reduce the amount of oil released by oil glands in your skin, and help your skin renew itself more quickly. Oral forms are used to treat severe nodular acne, while topical forms are used to treat less severe cases or have a cosmetic application such as wrinkle reduction. Retinoids may also be used for other purposes not listed in the medication guide.

Topical forms of retinoids can be absorbed thru the skin and can have systemic effects, which may result in Vitamin A toxicity when consuming Vitamin A at the same time. Whether using topical or oral forms of Isotretinoin, Tretinoin or Retinoic Acid, concurrent consumption of Vitamin A may increase the occurrence of adverse effects such as toxicity which can result in health problems such as liver damage or increased intracranial pressure.

Studies indicate that due to the large amounts of Vitamin A related chemicals within the aforementioned medications, it is prudent that patients do not take dietary supplements that contain Vitamin A so as to avoid the occurrence of Vitamin A toxicity.

At this time, a dietary supplement without Vitamin A has not been found within the patent database. More particularly, the invention relates to various compositions of dietary supplements designed to promote optimal levels of such nutrients in the body and methods of using such compositions without the use of Vitamin A. The composition of the dietary supplement also includes an increased amount of Vitamin B-12, as compared to generic brands, due to the common complaint of fatigue noted by patients using retinoids.

Linus Pauling Institute for Micronutrient Research states that retinoids should not be used in combination with vitamin A supplements, because they may increase the risk of vitamin A toxicity.

There are medications and many medical conditions that interact negatively with the consumption of Vitamin A, from allergies to endocrine disorders and chemotherapies, and are too numerous to itemize individually. However an example is given below.

Studies have estimated that 75% of people may be ingesting more than the USDA recommended daily allowance (RDA) for vitamin A on a regular basis in developed nations. The habitual intake of twice the RDA of vitamin A may be associated with osteoporosis and hip fractures. High vitamin A intake has been associated with spontaneous bone fractures in animals. Cell culture studies have linked increased bone resorption and decreased bone formation with high vitamin A intakes. This interaction may occur because vitamins A and D may compete for the same receptor and then interact with parathyroid hormone which regulates calcium. A study by Forsmo et al. shows a correlation between low bone mineral density and too high intake of vitamin A. A study conducted in Sweden supports this as it found that the amount of vitamin A in one serving of liver may impair the ability of vitamin D to promote calcium absorption.

Many common food items have Vitamin A added, such as varieties of cereals, bars and milks. Therefore it is not unlikely that the consumption of a combination of two or more items, or more than the recommended daily serving of these foods will result in exceeding the USDA's RDA of Vitamin A.

A study by Dr. K. Rothman concluded that a high dietary intake of vitamin A appears to be teratogenic. It found that among the babies born to women who took more than 10,000 IU of vitamin A per day in the form of supplements, the estimate was that about 1 infant in 57 had a malformation attributable to the supplement

In 2003, the Associated Press reported on a study showing that relatively small amounts of supplemental vitamin A may cause problems. The study conducted by researchers at Boston University says that “surprisingly low doses of vitamin A—as little as the amount contained in two or three multivitamin pills—may increase the risk of birth defects when taken early in pregnancy”.

Their article states that consuming an excess of 10,000 international units of vitamin A each day may be dangerous to the developing fetus.

According to the US government, a woman needs approximately 770 micrograms retinol activity equivalents (RAE) of vitamin A each day during pregnancy. (This is approximately equal to 2,565 IU)

The government recently changed the units they use to measure vitamin A from “retinol equivalents” (REs) to a more accurate measurement called “retinol activity equivalents” (which is expressed as mcg RAE). They also continue to express amounts of vitamin A in international units (IU), as those are the units used on vitamin labels.

Prenatal and daily vitamins usually contain 5,000 units or less. Taken in addition to foods that have Vitamin A added can cause an individual to easily exceed the RDA of RAE.

In the aforementioned study, the researcher found that “one of every 57 babies born to women who take more than 10,000 units of vitamin A will have a birth defect as a result'. Some defects noted involved malformations of the face, head, heart and nervous system, such as cleft lips and palates, serious heart problems and fluid on the brain. The study also states that women who took vitamin pills with more than 10,000 international units of vitamin A were five times as likely as those who took less than 5,000 units to have a birth defect linked to vitamin use. The risk was greatest when women took vitamin A during their first seven weeks of pregnancy.

In 2002, the Journal of the American Medical Association stated that “it appears prudent for all adults to take vitamin supplements.” The article examines the clinical applications of vitamins for the prevention of chronic diseases in adults. The authors, Robert H. Fletcher and Kathleen M. Fairfield from the Harvard School of Medicine, analyzed articles on vitamins in relation to chronic diseases published between 1966 and 2002, and concluded that an inadequate intake of several vitamins has been linked to the development of diseases including coronary heart disease, cancer, and osteoporosis. In the Apr. 9, 1998 issue of the New England Journal of Medicine an editorial entitled “Eat Right and Take a Multivitamin” that was based on studies that showed health benefits resulting from the consumption of nutritional supplements. Bruce Ames, a professor at the University of California and a senior scientist at Children's Hospital Oakland Research Institute (CHORI), suggests that “to maximize human health and lifespan, scientists must abandon outdated models of micronutrients” and that “a metabolic tune-up through an improved supply of micronutrients is likely to have great health benefits.”

U.S. Pat. No. 5,804,168 discloses a nutritional composition to protect skin from the damaging effects of sunlight comprising an antioxidant, such as vitamin A, an anti-inflammatory component, such as vitamin E or zinc, and an immunity-boosting compound such as echinacea or golden seal.

U.S. Pat Nos. 6,099,854 and 6,086,910 disclose and claim a dietary supplement flavonoid and polyphenol composition optionally including one or more of the following: Lutein, 2 to 50, mg, Beta carotene, 2 to 20 mg, Vitamin A, 400 to 600, Vitamin C, 75 to 250 mg, Folic Acid, 0.1 to 1.0 mg, Selenium, 80 to 120 mug, Copper, 2 to 4 mg, Zinc, 10 to 20 mg, Coenzyme Q10, 10 to 200, mg, Aspirin, 10 to 150

U.S. Pat No. 6,121,243 discloses the topical dermatological use of alpha-glucosyl rutin in combination with one or more cinnamic acids and optionally carotenoids (alpha-carotene, beta-carotene and lycopene), alpha-hydroxy acids, folic acid, vitamin C and derivatives, tocopherols, vitamin A and zinc and selenium.

U.S. Pat No. 6,103,756 discloses oral compounds and methods for treating diseases of the eye comprising: vitamin A, vitamin E, vitamin C, magnesium, selenium, bilberry extract L-taurine, lutein extract, lycopene extract, alpha lipoic acid, quercetin, rutin and citrus bioflavonoids. The formulation optionally contains at least one of the following: vitamin D3, thiamine, riboflavin, niacin, vitamin B6, folic acid, vitamin B12, biotin, pantothenic acid, calcium, iodine, zinc, copper, manganese, chromium, molybdenum, n-acetyl-cysteine, plant enzymes, biopene, malic acid, L-glycine, L-glutathionine or boron.

It should be noted that all the patents include the use of Vitamin A, a supplement not recommended by patients on Retinoids or other Vitamin A sensitive medications, certain medical conditions that are exacerbated by Vitamin A, or individuals wishing to avoid Vitamin A in supplements during pregnancy, as discussed above.

### The Recommended Dietary Allowance (RDA) for Vitamin A

The RDA for vitamin A was revised by the Food and Nutrition Board (FNB) of the Institute of Medicine in 2001. Below lists the RDA values in both micrograms (mcg) of Retinol Activity Equivalents (RAE) and international units (IU).

Recommended Dietary Allowance (RDA) for Vitamin A as
Preformed Vitamin A (Retinol Activity Equivalents)

| | | Males: | Females: |
|---|---|---|---|
| | | mcg/day | mcg/day |
| Life Stage | Age | (IU/day) | (IU/day) |
| Adolescents | 14-18 years | 900 (3,000 IU) | 700 (2,333 IU) |
| Adults | 19 years and older | 900 (3,000 IU) | 700 (2,333 IU) |
| Pregnancy | 18 years and younger | — | 750 (2,500 IU) |
| Pregnancy | 19 years and older | — | 770 (2,567 IU) |

Vitamin A is found in foods that come from animals such as whole eggs, milk, and liver. Most fat-free milk and dried nonfat milk solids sold in the United States are fortified with vitamin A to replace the amount lost when the fat is removed. Foods such as fortified breakfast cereals also provide vitamin A. The 2000 National Health and Nutrition Examination Survey (NHANES) indicated that major dietary contributors of Vitamin A are milk, margarine, eggs, beef liver and fortified breakfast cereals. Vitamin A in foods that come from animals is well absorbed.

| Food | Vitamin A (IU)* | % DV** |
|---|---|---|
| Liver, beef, cooked, 3 ounces | 27,185 | 545 |
| Liver, chicken, cooked, 3 ounces | 12,325 | 245 |
| Milk, fortified skim, 1 cup | 500 | 10 |
| Cheese, Cheddar, 1 ounce | 284 | 6 |
| Milk, whole (3.25% fat), 1 cup | 249 | 5 |
| Egg substitute, ¼ cup | 226 | 5 |
| Margarine, soft, corn oil, 1 tsp | 165 | 4 |
| Foods Fortified with Vitamin A | | |
| Total Cereal | 485 | 10 |
| Quaker Regular Instant Oatmeal | 970 | 20 |
| Cheerios | 485 | 10 |
| Raisin and Spice Instant Oatmeal | 1601 | 33 |
| Kellogg's All Bran Wheat Flakes | 747 | 15 |
| Orange Juice | 194 | 4 |
| Peanut Butter | 9797 | 202 |

It should be noted that according to a study performed by the Center for Food Safety and Applied Nutrition, the amount of cereal actually consumed by adults during a meal is approximately 200% of the labeled serving size.

### The Recommended Dietary Allowance (RDA) for Other Vitamins and Minerals

The table below is the United States Recommended Daily Allowance (US RDA) as established by the Department of Health and Human Services and the Department of Agriculture. The US RDA is a list of vitamins and minerals for which minimum or maximum daily nutritional requirements have been established.

| Essential Nutrient | 100% (D.V.) | |
|---|---|---|
| Total Fat | 65 | g |
| Saturated Fat | 20 | g |
| Cholesterol | 300 | mg |
| Sodium | 2,400 | mg |
| Potassium | 3,500 | mg |
| Total Carbohydrate | 300 | g |
| Dietary Fiber | 25 | g |
| Protein | 50 | g |
| Vitamin C | 60 | mg |
| Calcium | 1,000 | mg |
| Iron | 18 | mg |
| Vitamin D | 400 | IU |
| Vitamin E | 30 | IU |
| Vitamin K | 80 | mcg |
| Thiamine (Vitamin B1) | 1.5 | mg |
| Riboflavin (Vitamin B2) | 1.7 | mg |
| Niacin | 20 | mg |
| Vitamin B6 | 2.0 | mg |
| Folate | 400 | mcg |
| Vitamin B12 | 6.0 | mcg |
| Biotin | 300 | mcg |
| Pantothenic Acid | 10 | mg |
| Phosphorus | 1,000 | mg |
| Iodine | 150 | mcg |
| Magnesium | 400 | mg |
| Zinc | 15 | mg |
| Selenium | 70 | mcg |
| Copper | 2.0 | mg |
| Manganese | 2.0 | mg |
| Chromium | 120 | mcg |
| Molybdenum | 75 | mcg |
| Chloride | 3,400 | mg |

### SUMMARY OF THE INVENTION

This invention relates to a dietary supplement that is specifically designed for use in three categories of patent type; patients undergoing treatment with oral or topical forms of retinoids such as Isotretinoin, Tretinoin and Retinoic Acid; patients with medical conditions/treatments that are aggravated by the consumption of Vitamin A; individuals in the prenatal period wishing to avoid the consumption of Vitamin A in supplements.

The dietary supplement is not limited by the inclusion of specific vitamins, minerals or other nutrients, but rather the exclusion specifically of Vitamin A for the purpose outlined above.

### DESCRIPTION OF THE PREFERRED EMBODIMENTS

While the patent and scientific literature is replete with nutritional supplement and vitamin formulations, there is no disclosure of the present invention for the promotion and maintenance of health. Even though some of the aforementioned ingredients are available in common multi-vitamin supplements, they also contain Vitamin A. As previously mentioned Vitamin A is not recommended for consumption by patients undergoing treatment with oral or topical forms of retinoids such as Isotretinoin, Tretinoin and Retinoic Acid; patients with medical conditions/treatments that are aggravated by the consumption of Vitamin A; individuals in the prenatal period wishing to avoid the consumption of Vitamin A in supplements.

Furthermore, there has been no suggestion as to the use of these supplements for these patient types.

Other nutritional supplements can be added to the formulation, although they are not essential for its function. Any known dietary supplement may be added to the above listed essential components. Preferred optional components include those vitamins and minerals that are known to play a role in maintaining healthy skin and promoting general health and well being. Some of these optional components and their function are further described below.

Vitamin C is required for collagen formation, healthy strong blood vessels and joint health. It plays a co-factor role in the hydroxylation of lipine and proline and specifically induces collagen synthesis on a molecular level. Vitamin C plays a role in infection resistance and in capillary formation in the skin. Deficiencies in the diet lead to disorders in the connective tissues and skin including rickets and an increase in size of acne lesions.

Vitamin E is a fat-soluble vitamin and an active free radical scavenger that plays a role in stabilizing cell membranes by inhibiting the oxidation of poly-unsaturated fatty acids. Vitamin E deficiency can result in impaired vitamin A absorption. When combined with selenium and provided as a supplement, vitamin E has been show to help acne patients with low red blood cell glutathione peroxidase levels, and is also beneficial in scleroderma, seborrheic dermatitis and in the prevention of melanoma.

Riboflavin (vitamin B2) is an essential B complex vitamin. Twenty seven percent of adolescent acne patients are deficient in riboflavin. Deficiencies of riboflavin are also linked to seborrheic dermatitis and other skin disorders resulting from defective collagen synthesis.

Vitamin B6 (pyroxidine) plays a vital role in the multiplication and replication of cells. Pyroxidine is involved in tryptophan metabolism and also in the metabolism of essential fatty acids. A deficiency of pyroxidine can result in seborrheic lesions. Pyroxidine is also beneficial in premenstrual acne flare-ups and may be beneficial in acne vulgaris and acne rosacea.

Folic acid co-enzymes participate in single carbon transfers including purine biosynthesis and conversions among 3 amino acids. Ultraviolet light has been shown to lower serum folate levels, implying in vivo photolysis of folic acid. Psoriasis patients are known to be deficient in folic acid. Supplementation with folic acid may benefit psoriasis and seborrheic dermatitis patients.

Copper is a component of tyrosinase, a metalloenzyme essential for melanin production. It is also a co-factor of other enzymes in wound healing and plays important roles in collagen formation, elastin production and hair maturation.

Manganese is present in high concentrations in melanocytes and may be involved in the auto-oxidation of melanin granules. Manganese is necessary for arginase activity in the epidermis. Manganese deficiency is associated with dermatitis and affects hair color and growth.

Nickel is a cofactor in nucleic acid metabolism and is part of the urease group of metalloenzymes. Psoriasis patients have been shown to have nickel deficiencies. Silicon is required by the body for the proper functioning of prolyhydrogenase, an important enzyme in the formation of collagen in connective tissues such as skin, ligaments and tendons. The highest concentrations of silicon are found in the skin and hair. The overall silicon content of the skin decreases with age.

Zinc is an essential trace element with significant antioxidant activity that is also linked to collagen production. Up to 20% of the body's stores of zinc are found in the skin, where zinc is 3-6 times more concentrated in the epidermis than the dermis. Zinc deficiency manifests itself clinically as dermatitis and alopecia and is also is associated with psoriasis. Low serum zinc levels slow wound healing and aggravates existing skin disorders. Zinc supplementation has been shown to speed postoperative wound healing and to be of benefit to acne patients.

While some of the aforementioned ingredients are available in common multivitamin/multimineral supplements, they also include Vitamin A, which could cause toxicity to Retinoid patients. Furthermore, there has been, apparently, no suggestion as to the use of these ingredients for the three patient types described herein.

Delivery of therapeutic or sub-therapeutic quantities of the above ingredient compositions may be accomplished through administration of single or multiple units given at one time or multiple times throughout the day. It is important to note that these formulations are not meant as a replacement of those ingredients naturally produced in the body and/or consumed in the diet, but rather represent a supplement designed to increase normal levels of the above ingredients in the body.

Solid dosage forms for oral administration include capsules, tablets, pills, powders, granules, gelatin, nutrition bars, beverages and various other food compositions. Solid dosage forms of the present invention may be created using any pharmaceutically acceptable excipients such as: a) fillers or extenders such as starches, lactose, sucrose, glucose, mannitol, cellulose, maltodextrin and silicic acid; b) binders such as, for example, carboxymethylcellulose, alginates, gelatin, polyvinylpyrrolidone, sucrose, and acacia; c) humectants such as glycerol; d) disintegrating agents such as sodium starch glycolate, agar-agar, calcium carbonate, cornstarch, potato or tapioca starch, alginic acid, certain silicates, and sodium carbonate; e) wetting agents such as, for example, mineral oil, polyethylene glycol, cetyl alcohol and glycerol monostearate; and f) lubricants such as magnesium stearate, stearic acid, talc, calcium stearate, solid polyethylene glycols, sodium lauryl sulfate, and mixtures thereof.

The solid compositions described above may also be employed as fillers in soft and hard-filled gelatin capsules using such excipients as lactose or milk sugar as well as high molecular weight polyethylene glycols and the like.

The solid dosage forms of tablets, capsules, powders, and granules can be prepared with coatings and shells such as enteric coatings and other coatings.

Optionally, the supplement can be coated or flavored to mask or improve the taste, appearance or to alter the release rate.

The active compounds can also be in microencapsulated form, if appropriate, with one or more of the above-mentioned excipients.

Liquid dosage forms for oral administration include pharmaceutically acceptable emulsions, solutions, suspensions, syrups and elixirs.

Besides inert diluents, the oral compositions can also include adjuvants such as wetting agents, emulsifying and suspending agents, sweetening, flavoring, and perfuming agents.

Alternative embodiments of the present invention include, but are not limited to, tablets, capsules, liquid, wafer, cookie, gelatin, or liquid filled capsules.

The ingredients may constitute any part of the form the supplement is prepared and is not limited any one aspect

Accordingly, it will be understood that the preferred embodiments of the invention have been disclosed by way of example and that other modifications, alterations or variations may transpire without departing from the scope and spirit of the aforementioned claims.

What is claimed is:

1. A dietary supplement composition for general health and specifically does not contain Vitamin A for individuals utilizing topical and or varieties of prescribed and over-the-counter (OTC) forms of retinoids such as Isotretinoin, Tretinoin, and Retinoic Acid.

2. A dietary supplement composition for general health and specifically does not contain Vitamin A for individuals with Vitamin A sensitivities, allergies and medical conditions wherein consuming Vitamin A or its precursors, such as carotinoids, is contraindicated.

3. A dietary supplement composition for general health and specifically does not contain Vitamin A for pregnant women wishing to prevent the possible teratogenic effects of the over-consumption of vitamin A.
